(19) United States
(12) Patent Application Publication
(10) Pub. No.: US 2017/0277903 A1
(43) Pub. Date: Sep. 28, 2017

(54) Data Protection Using Virtual Resource Views

(71) Applicant: QUALCOMM Incorporated, San Diego, CA (US)

(72) Inventors: Mihai Christodorescu, San Jose, CA (US); Dinakar Dhurjati, Santa Clara, CA (US); Nayeem Islam, Palo Alto, CA (US)

(21) Appl. No.: 15/076,936

(22) Filed: Mar. 22, 2016

(51) Int. Cl. G06F 21/62; H04L 9/00; G06F 9/455; G06F 21/60

(52) U.S. Cl. CPC G06F 21/6218; G06F 21/602; H04L 9/008; G06F 9/455

(57) ABSTRACT

Embodiments include computing devices, systems, and methods for protecting data using virtual views of resource contents. A virtualization interface monitor may monitor a request to access a computing device resource by a first requesting entity and determine whether the first requesting entity is an owner of the computing device resource. A data protection system may provide, to the first requesting entity, an unobscured virtual view of resource contents of the computing device resource in response to determining that the first requesting entity is the owner of the computing device resource. A resource content cryptographic device may obscure a virtual view of the resource contents of the computing device resource in response to determining that the first requesting entity is a non-owner of the computing device resource. The data protection system may provide, to the first requesting entity, the obscured virtual view of resource contents of the computing device resource.

### BACKGROUND

In any computer system with one or more processors and one or more peripherals, resource management software runs with high privilege. Using a protection ring model as an example, an operating system runs in ring-0, with full access to all hardware, and a hypervisor runs below ring-0, with full access to all hardware. When a resource manager assigns a resource to a task, for example when the operating system assigns a memory page to a process, the resource manager maintains full access to the resource. Maintaining full access to the resource enables the resource manager to later manage the resource on behalf of the task. The resource manager can also have read/write access to the resource, which may enable the resource to implement resource management. For example, the operating system reads the memory page assigned to the process to relocate the memory page or swap the process out of memory.

Resource managers, including operating systems, hypervisors, and TrustZones, are vulnerable pieces of software. Due to their innate complexity, elimination of all bugs is close to impossible. An attack that exploits a vulnerability in a resource manager can lead to failure of the computer system. Because the high privilege of resource manager, an attacker can have complete access to the computer system. Therefore, attackers are incentivized to find and exploit flaws in resource managers.

### SUMMARY

The methods and apparatuses of various embodiments provide apparatus and methods for protecting data using virtual views of resource contents. Various embodiments may include a virtualization interface monitor of a computing device monitoring a request to access a computing device resource by a first requesting entity. The virtualization interface monitor may determine whether the first requesting entity is an owner of the computing device resource. A data protection system of the computing device to the first requesting entity may provide an unobscured virtual view of resource contents of the computing device resource in response to determining that the first requesting entity is the owner of the computing device resource. The data protection system may provide to the first requesting entity an obscured virtual view of resource contents of the computing device resource in response to determining that the first requesting entity is a non-owner of the computing device resource.

In some embodiments, the resource content cryptographic device may determine whether the first requesting entity has a certified function, and determine an access type for the first requesting entity in response to determining the first requesting entity has a certified function. The resource content cryptographic device may obscure the virtual view of the resource contents of the computing device resource in response to determining that the first requesting entity is a non-owner of the computing device resource using an obscuring level based on the access type.

In some embodiments, the access type may include partially obscured and obscured. The resource content cryptographic device may obscure the virtual view of the resource contents of the computing device resource using an obscuring level based on the access type by encrypting the virtual view of the resource contents of the computing device resource using homomorphic encryption in response to determining that the access type for the first requesting entity is partially obscured. The resource content cryptographic device may encrypt the virtual view of the resource contents of the computing device resource using strong encryption in response to determining that the access type for the first requesting entity is obscured.

In some embodiments, the virtualization interface monitor may monitor a virtualization interface for changes in ownership of the computing device resource, and store a first owner identifier of the first requesting entity correlated with a virtual resource identifier of the computing device resource for the first requesting entity. In such embodiments, the first owner identifier may indicate that the first requesting entity is granted ownership of the computing device resource and the virtual resource identifier is mapped to a physical resource identifier of the computing device resource.

In some embodiments, monitoring a virtualization interface for a change in ownership of the computing device resource may include monitoring for a request for ownership of the computing device resource by a second requesting entity.

In some embodiments, the virtualization interface monitor may determine whether the first requesting entity is an owner of the computing device resource by comparing a virtual resource identifier of the request to access the computing device resource with a stored owner identifier that correlated with a virtual resource identifier of the computing device resource. The virtualization interface monitor may determine that the first requesting entity is the owner of the computing device resource when the virtual resource identifier of the request to access the computing device resource and the virtual resource identifier of the computing device resource match.

In some embodiments, the owner of the computing device resource may include an application, and the non-owner of the computing device resource may include a resource manager including one of an operating system kernel, a hypervisor, and a TrustZone.

Various embodiments may include a computing device configured for protecting data using virtual views of resource contents. The computing device may include a data protection system including a virtualization interface monitor and a resource content cryptographic device. One or more processors of the computing device may be configured with data protection system-executable instructions, virtualization interface monitor-executable instructions, and resource content cryptographic device-executable instructions to perform operations of one or more of the embodiment methods summarized above.

Various embodiments may include a computing device configured for protecting data using virtual views of resource contents having means for performing functions of one or more of the embodiment methods summarized above.

Various embodiments may include a non-transitory processor-readable storage medium having stored thereon processor-executable instructions configured to cause one or more processors of a computing device to perform operations of one or more of the embodiment methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating a computing device suitable for implementing an embodiment.

FIG. 2 is a component block diagram illustrating an example multi-core processor suitable for implementing an embodiment.

FIG. 3 is a component block diagram illustrating a data protection system suitable for implementing an embodiment.

FIG. 4 is a resource ownership table according to an embodiment.

FIG. 5 is an access request certification table according to an embodiment.

FIG. 6 is a process flow diagram illustrating an embodiment method for protecting data using virtual resource views.

FIG. 7 is a process flow diagram illustrating an embodiment method for tracking ownership of computing device resources.

FIG. 8 is a process flow diagram illustrating an embodiment method for using certifications for applying encryption to virtual views of resource content.

FIG. 9 is component block diagram illustrating an example mobile computing device suitable for use with the various embodiments.

FIG. 10 is component block diagram illustrating an example mobile computing device suitable for use with the various embodiments.

FIG. 11 is component block diagram illustrating an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The terms “computing device” and “mobile computing device” are used interchangeably herein to refer to any one or all of, cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a multi-core programmable processor. The term “computing device” may further refer to stationary computing devices including personal computers, desktop computers, all-in-one computers, workstations, super computers, mainframe computers, embedded computers, servers, home theater computers, and game consoles. The various embodiments are particularly useful for mobile computing devices, such as smartphones, which have limited memory and battery resources. However, the embodiments are generally useful in any electronic device that implements a plurality of memory devices and a limited power budget in which reducing the power consumption of the processors can extend the battery-operating time of a mobile computing device.

Embodiments may include methods, systems, and devices for separating resource management tasks from high-privilege access permissions of resource managers, such as operating systems including an operating system kernel, hypervisors, and/or TrustZones. Monitoring of virtualization interfaces used to translate access requests for various resources may be used to distinguish owner application accesses and resource manager accesses to a resource. Different views of the same resource may be provided to the owner application and the resource manager. Different levels of protection of the resource contents related to the access request may be provided based on a planned operation by an accessor of the resource and a sensitivity of the resource data.

Resources can be managed (e.g., moved, copied, etc.) by a resource manager without having access to their contents, such as the resource data, while applications need access to the resource contents to implement various processes. Virtualization interfaces may be monitored to determine whether to mask the resource contents from the resource manager while allowing the resource manager to implement management functions, and while allowing a resource owning application to access the resource contents to implement the processes. Virtualization interface monitors and resource content cryptographic devices may be implemented in hardware configured to distinguish owner application accesses and resource manager accesses to a resource and to limit access of the resource contents by the resource manager.

The virtualization interface monitor may include a resource ownership tracker configured to store and update ownership of resources of the computing device system. The virtualization interface monitor may be configured to determine whether an access request for a resource is issued by the owner application of the resource or the resource manager of the computing device system. The resource content cryptographic device may encrypt the contents of the resource in response to a determination that the access request is issued by the resource manager. The resource content cryptographic device may provide the contents of the resource in an unencrypted form in response to a determination that the access request is issued by the owner application.

The resource manager may assign the resource to the application. The application may request ownership of the resource, and the virtualization interface monitor may update the owner of the resource.

The resource manager and the owner application of the resource may be provided with different virtual representations of the resource. Each virtual representations of the resource may include different mappings of virtual memory addresses to physical memory addresses of the resource.

The virtualization interface monitor may receive, detect, or intercept a request to access an owned resource. The virtualization interface monitor may identify whether the requesting entity is the resource manager or the resource owner application by a virtual memory address of the access request. In response to determining that the requesting entity is the resource owner application, the resource content cryptographic device may provide the owner application access to an unencrypted virtual representation of the resource contents. In response to determining that the requesting entity is the resource manager, the resource content cryptographic device may encrypt a virtual representation of the contents of the resource and provide the resource manager access to the encrypted virtual representation.

In some implementations, the resource content cryptographic device can vary the protection of the resource content based on a planned operation by the requesting entity and a sensitivity of the resource contents. The resource content cryptographic device may support different types of encryption, such as strong encryption and signing requirements, or partially homomorphic encryption.

A certification device may store and update compiler certificates for applications and resource managers stating that a compiler guarantees certain operations are performed by a particular software component. The compiler certificates may be correlated with a designated type of encryption. The resource content cryptographic device may implement the different types of encryption based on a determination of the requesting entity and the correlations maintained by the certification device for various resource owner applications, non-owner applications, and resource managers.

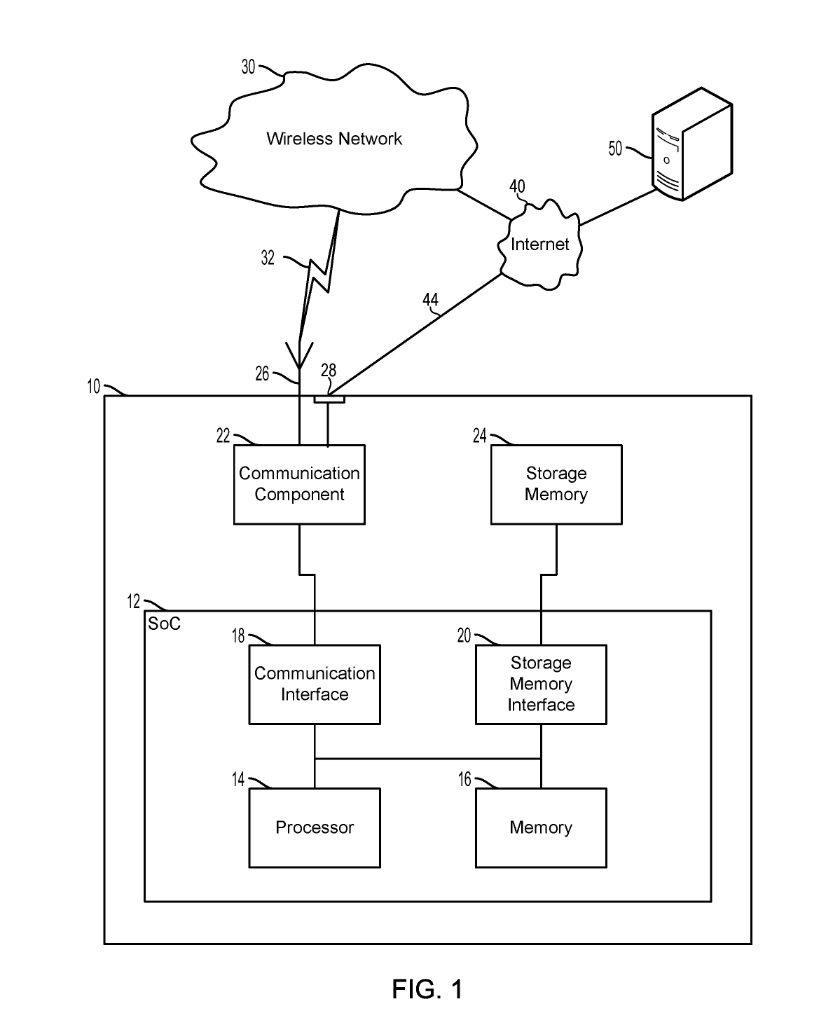

FIG. 1 illustrates a system including a computing device 10 in communication with a remote computing device 50 suitable for use with the various embodiments. The computing device 10 may include a system-on-chip (SoC) 12 with a processor 14, a memory 16, a communication interface 18, and a storage memory interface 20. The computing device 10 may further include a communication component 22 such as a wired or wireless modem, a storage memory 24, an antenna 26 for establishing a wireless connection 32 to a wireless network 30, and/or the network interface 28 for connecting to a wired connection 44 to the Internet 40. The processor 14 may include any of a variety of hardware cores, for example a number of processor cores.

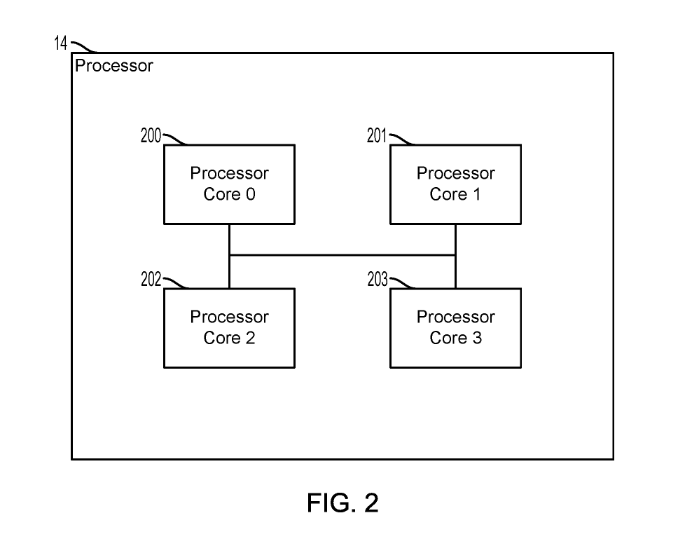

The term “system-on-chip” (SoC) is used herein to refer to a set of interconnected electronic circuits typically, but not exclusively, including a hardware core, a memory, and a communication interface. A hardware core may include a variety of different types of processors, such as a general purpose processor, a central processing unit (CPU), a digital signal processor (DSP), a graphics processing unit (GPU), an accelerated processing unit (APU), an auxiliary processor, a single-core processor, and a multi-core processor. A hardware core may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon. The SoC 12 may include one or more processors 14. The computing device 10 may include more than one SoCs 12, thereby increasing the number of processors 14 and processor cores. The computing device 10 may also include processors 14 that are not associated with an SoC 12. Individual processors 14 may be multi-core processors as described below with reference to FIG. 2. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. In an embodiment, one or more memories 16 may include volatile memories such as random access memory (RAM) or main memory, or cache memory. These memories 16 may be configured to temporarily hold a limited amount of data received from a data sensor or subsystem. These memories 16 may be configured to temporarily hold data and/or processor-executable code instructions that are requested from non-volatile memory, loaded to the memories 16 from non-volatile memory in anticipation of future access based on a variety of factors. These memories 16 may be configured to temporarily hold intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a miss, because the requested data or processor-executable code is not located in the memory 16. In response to a miss, a memory access request to another memory 16 or storage memory 24 may be made to load the requested data or processor-executable code from the other memory 16 or storage memory 24 to the memory 16. Loading the data or processor-executable code to the memory 16 in response to execution of a function may result from a memory access request to another memory 16 or storage memory 24, and the data or processor-executable code may be loaded to the memory 16 for later access.

The communication interface 18, communication component 22, antenna 26, and/or network interface 28, may work in unison to enable the computing device 10 to communicate over a wireless network 30 via a wireless connection 32, and/or a wired network 44 with the remote computing device 50. The wireless network 30 may be implemented using a variety of wireless communication technologies, including, for example, radio frequency spectrum used for wireless communications, to provide the computing device 10 with a connection to the Internet 40 by which it may exchange data with the remote computing device 50.

The storage memory interface 20 and the storage memory 24 may work in unison to allow the computing device 10 to store data and processor-executable code on a non-volatile storage medium. The storage memory 24 may be configured much like an embodiment of the memory 16 in which the storage memory 24 may store the data or processor-executable code for access by one or more of the processors 14. The storage memory 24, being non-volatile, may retain the information even after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be differently arranged and/or combined while still serving the necessary functions. Moreover, the computing device 10 may not be limited to one of each of the components, and multiple instances of each component may be included in various configurations of the computing device 10.

FIG. 2 illustrates a multi-core processor 14 suitable for implementing an embodiment. The multi-core processor 14 may have a plurality of homogeneous or heterogeneous processor cores 200, 201, 202, 203. The processor cores 200, 201, 202, 203 may be homogeneous in that, the processor cores 200, 201, 202, 203 of a single processor 14 may be configured for the same purpose and have the same or similar performance characteristics. For example, the processor 14 may be a general purpose processor, and the processor cores 200, 201, 202, 203 may be homogeneous general purpose processor cores. Alternatively, the processor 14 may be a graphics processing unit or a digital signal processor, and the processor cores 200, 201, 202, 203 may be homogeneous graphics processor cores or digital signal processor cores, respectively. For ease of reference, the terms “processor” and “processor core” may be used interchangeably herein.

The processor cores 200, 201, 202, 203 may be heterogeneous in that, the processor cores 200, 201, 202, 203 of a single processor 14 may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores. In similar embodiments, the SoC 12 may include a number of homogeneous or heterogeneous processors 14.

In the example illustrated in FIG. 2, the multi-core processor 14 includes four processor cores 200, 201, 202, 203 (i.e., processor core 0, processor core 1, processor core 2, and processor core 3). For ease of explanation, the examples herein may refer to the four processor cores 200, 201, 202, 203 illustrated in FIG. 2. However, the four processor cores 200, 201, 202, 203 illustrated in FIG. 2 and described herein are merely provided as an example and in no way are meant to limit the various embodiments to a four-core processor system. The computing device 10, the SoC 12, or the multi-core processor 14 may individually or in combination include fewer or more than the four processor cores 200, 201, 202, 203 illustrated and described herein.

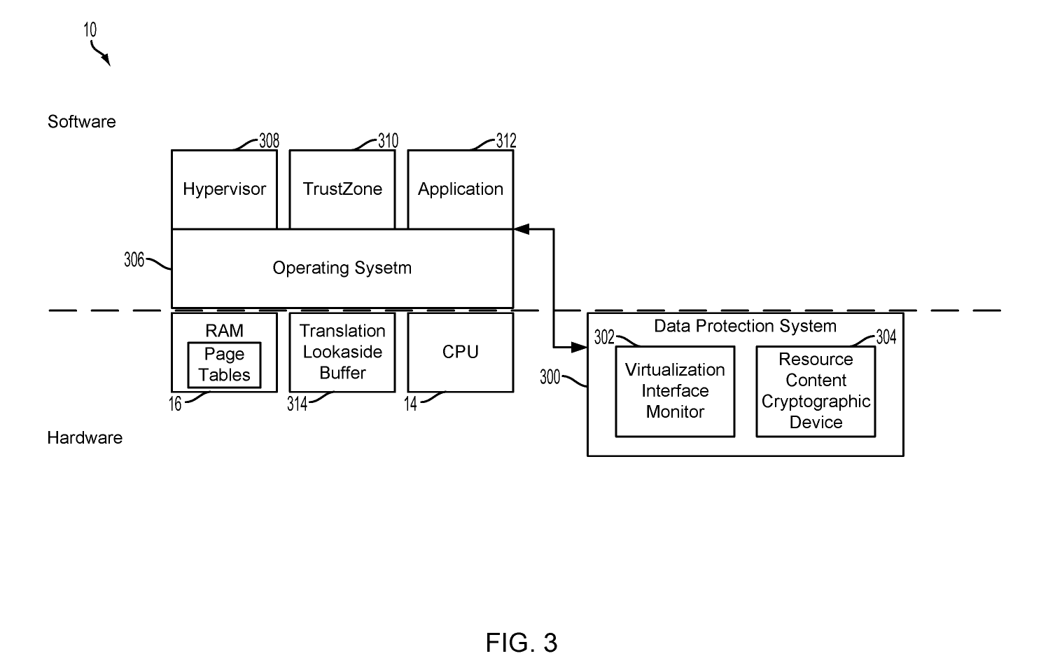

FIG. 3 illustrates a data protection system according to an embodiment. The data protection system 300 may be configured to monitor a virtualization interface for a computing device resource, and protect the resource contents by encrypting some of the resource contents and providing different encrypted and unencrypted virtual views of the resource contents to different components of the computing device 10 requesting access to or use of a resource (“requesting components”). The data protection system 300 may include a virtualization interface monitor 302 and a resource content cryptographic device 304.

The virtualization interface monitor 302 may be configured to track ownership of computing device resources, such as address locations of the memory 16, disk blocks of the storage memory 24, and network card queue identifiers of the communication component 22. Ownership of the resources may be attributed to an application 312, an operating system 306, a hypervisor 308, and/or a TrustZone 310 executed on the computing device 10.

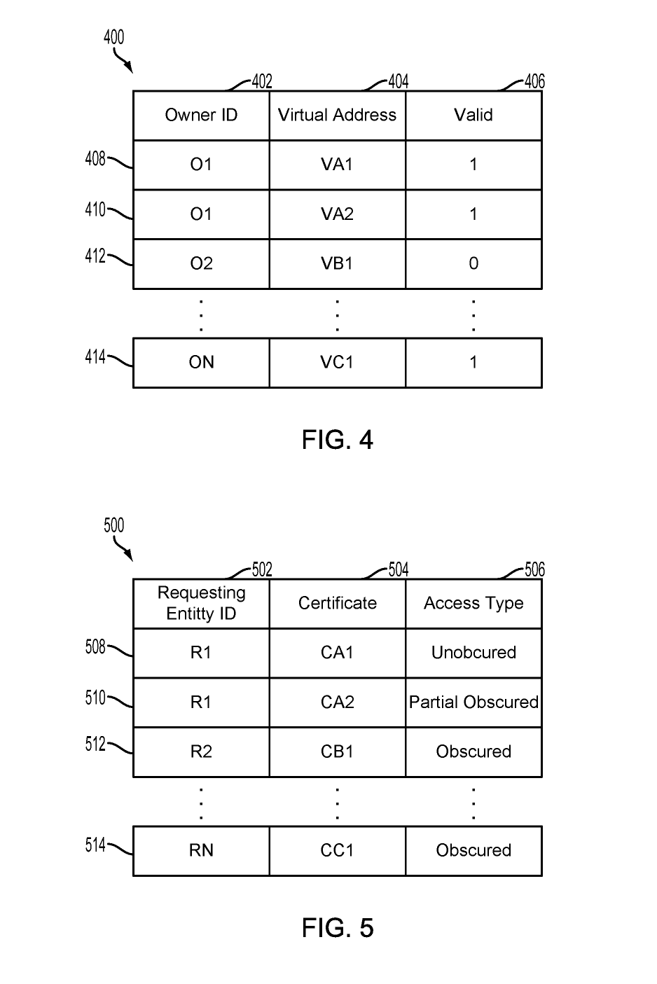

The attribution of ownership of a computing device resource may be stored by the virtualization interface monitor 302 in a table or a data structure configured to link and/or arrange multiple data. Without limiting the disclosure, for ease of explanation, reference herein is made to an ownership table (not shown) stored by the virtualization interface monitor 302 and described further herein with reference to FIG. 4. The ownership table may correlate owner identifiers (ID), configured to indicate one of the operating system 306, the hypervisor 308, the TrustZone 310, and/or the application 312, with a virtual resource identifier, such as a virtual address, of the owned computing device resource.

Different virtual resource identifier to physical resource identifier mappings, such as virtual-address-to-physical-address mappings, for the computing device resources may be used for the potential and actual owners, e.g., different potential owners may use different virtual addresses mapped to the same physical address. Because of the different virtual resource identifier to physical resource identifier mappings, the virtualization interface monitor 302 may use the virtual resource identifier of a declaration or request for ownership of the computing device resource to correlate the owner with the owned computing device resource.

The virtualization interface monitor 302 may receive, detect, or intercept declarations of or requests for ownership of the computing device resources by the assigning memory resource managers and the entity assigned ownership of the computing device resource. The assigning memory resource managers may include the operating system 306, the hypervisor 308, and/or the TrustZone 310. The entity assigned ownership of the computing device resource may include the operating system 306, the hypervisor 308, the TrustZone 310, and/or the application 312. In some embodiments, the virtualization interface monitor 302 may manage the ownership table so that entries indicating ownership of a computing device resource may be deleted or indicated as invalid upon a change in ownership of the computing device resource. Entries may be added or marked valid for the new owner of the computing device resource.

In some embodiments, the virtualization interface monitor 302 may track certification indicating allowed functions of the resource access requester. Certification of the functions may be preprogrammed by developers of the functions or identified by a compiler executed on the computing device 10. Certifications may be applicable to functions of the application 312, the operating system 306, the hypervisor 308, and/or the TrustZone 310. In some embodiments, the types of accesses to the resource contents that need to implement the certified functions may be correlated with the certificates.

The types of accesses needed to implement the functions may indicate whether the function needs full, unobscured access to the resource contents, partially obscured access to the resource contents, or obscured access to the resource contents. Unobscured access to the resource contents may allow a view of the resource contents as stored, without any changes or manipulations to obscure the resource contents, and may allow for reading and writing the resource contents. Partially obscured access to the resource contents may allow for searching or arithmetic manipulation of the resource contents, and may be achieved through application of partially or fully homomorphic encryption. Obscured access to the resource contents may allow for resource management operations that may be executed without read or write access to the resource contents, and may be achieved through application of strong encryption and signing requirements.

The virtualization interface monitor 302 may store the attribution of function certification to a requester for access to a computing device resource in a table or a data structure configured to link and/or arrange multiple data. In some embodiments, the virtualization interface monitor 302 may also store the type of access needed to implement the certified function. Without limiting the disclosure, for ease of explanation, reference herein is made to a certification table (not shown) stored by the virtualization interface monitor 302 and described further herein with reference to FIG. 5.

The virtualization interface monitor 302 may receive, detect, or intercept requests for access to computing device resources by access requesters. In a manner similar to tracking the ownership of the computing device resources described herein, the virtualization interface monitor 302 may use the virtual resource identifier of the requests for access to computing device resource to determine whether the requesting entity is an owner. The virtualization interface monitor 302 may find the requesting entity correlated with the virtual resource identifier of the request for access to the computing device resource. In some embodiments, the virtualization interface monitor 302 may use the ownership table to determine whether the requesting entity is an owner by comparing the virtual resource identifier of the request and a requesting entity identifier, to the ownership identifier. In some embodiments, the virtualization interface monitor 302 may use the requesting entity identifier and/or the requested access or function of the request for access to the computing device resource to locate the function certifications for the requesting entity in the certification table. The virtualization interface monitor 302 may identify the type of access correlated with the requesting entity identifier and/or the function certification for the request for access to the computing device resource. In any of these embodiments, the virtualization interface monitor 302 may transmit any data relating to the request for access to the computing device resource stored in the ownership table and/or the certification table to the resource content cryptographic device 304.

The resource content cryptographic device 304 may be configured to determine the type and/or level of obscureness to apply to a virtual view of the resource contents, and to provide the virtual view of the resource contents in response to the request for access to the computing device resource. The type and/or level of obscureness may include various types and levels of encryption. The encryption applied to the virtual view of the computing device resources may include strong encryption and signing requirements to completely obscure the resource contents from the requesting entity. The encryption applied to the virtual view of the computing device resources may include partially or fully homomorphic encryption to obscure the resource contents from the requesting entity, but to allow the requesting entity to search or arithmetically manipulate the ciphertext resulting from the homomorphic encryption. Operations on the ciphertext may produce corresponding results in the decrypted resource contents without allowing the requesting entity to read the decrypted resource contents. The encryption applied to the virtual view of the computing device resources may include encryption that may be decrypted by the owner to allow the owner to access the virtual copy of the resource contents. In some embodiments, no encryption may be applied to the virtual view of the computing device resources to allow the owner to access the virtual copy of the resource contents.

To determine the type and/or level of encryption to apply to a virtual view of the resource contents, the resource content cryptographic device 304 may correlate data received from the virtualization interface monitor 302 with a type and/or level of encryption. The data received from the virtualization interface monitor 302 may include, for example, owner identifier, requesting entity identifier, whether the requesting entity is the owner of the computing device resource, function certification, type of access, and/or the virtual resource identifier, such as the virtual address, or corresponding physical address of the request for access to the computing device resource.

The resource content cryptographic device 304 may receive the data from the virtualization interface monitor 302 and identify a type and/or level of encryption correlated with the data from virtualization interface monitor 302. In some embodiments, the type and/or level of encryption may be provided by the virtualization interface monitor 302 as part of the type of access data. In some embodiments, the resource content cryptographic device 304 may determine the type and/or level of encryption using programmed correlations between the data received from virtualization interface monitor 302 and the type and/or level of encryption. For example, data indicating that the requesting entity is the owner may be correlated with light or no encryption, while data indicating that the requesting entity is not the owner may be correlated with strong encryption. Similarly, data indicating that the requested function is a certified function of a non-owner may be correlated with full or partial homomorphic encryption, and data indicating that the requested function is a non-certified function of a non-owner may be correlated with strong encryption.

The data protection system 300 may retrieve the requested resource contents from the computing device resource, and the resource content cryptographic device 304 may apply a type and/or level of encryption to a virtual view of the retrieved resource contents. The data protection system 300 may return the obscured or unobscured virtual view of the requested resource contents to the requesting entity.

In some embodiments, the data protection system 300 may retrieve the requested resource contents from the computing device resource and the virtualization interface monitor 302 may transmit a signal based on the type of access for the request for access to the computing device resource. Different signals may trigger the resource content cryptographic device 304 to apply a type and/or level of obscureness to a virtual view of the retrieved resource contents. The data protection system 300 may return the encrypted or unencrypted virtual view of the requested resource contents to the requesting entity.

The data protection system 300 may be implemented in hardware as illustrated in FIG. 3. The computing device 10, may execute software, including the operating system 306, the hypervisor 308, the TrustZone 310, and/or the application 312. The computing device 10 may include hardware components, such as the memory 16, which may include random access memory (RAM) storing page tables, a translation lookaside buffer 314, a processor 14, which may include a CPU, and the data protection system 300. The data protection system 300 may include dedicated hardware or general purpose hardware, such as an SoC 12 or a processor 14, configured to implement the data protection system 300. The virtualization interface monitor 302 may include dedicated hardware or general purpose hardware, such as a processor 14 or processor core 200, 201, 202, 203, and a memory 16, which may include a buffer. The resource content cryptographic device 304 may include dedicated hardware or general purpose hardware, such as a processor 14, processor core 200, 201, 202, 203, and an encryption engine or hardware accelerator, and a memory 16, which may include a buffer.

FIG. 4 illustrates a non-limiting example of an ownership table 400 that the data protection system 300 may use to store data of the ownership of the computing device resources. Various implementations may include different combinations and ordering of ownership data, including owner identifiers, virtual resource identifiers, such as virtual addresses, physical resource identifiers, such as physical addresses, and validity indicators. In some implementations, the terms virtual resource identifiers and physical resource identifiers may be used interchangeably.

The example ownership table 400 may include an owner identifiers column 402 and a virtual resource identifiers column 404. As discussed further below, the ownership table 400 may also include an optional validity indicators column 406. The ownership table 400 may include multiple rows, for example, rows 408-414, each representing different ownership of a computing device resource.

The owner identifiers column 402 may include unique identifiers for each owner or potential owner of the computing device. The owner identifiers may be used to communicate the identity of an entity requesting access to a computing device resource that is an owner of the computing device resource.

The virtual resource identifiers column 404 may include a virtual resource identifier, such as a virtual address, that is mapped to a physical resource identifier of a computing device resource, for example, according to a virtual address to physical address map, for a correlated owner or potential owner of the same entry, as in row 408-414. As noted, other data may be used to correlate an owner or potential owner with a computing device resource, including the physical address of the computing device resource and a physical computing device resource identifier.

In some implementations, the ownership table 400 only includes entries for current owners of computing device resources. In such implementations, an entry may be removed from the ownership table 400 in response to a change in ownership of a computing device resource. Removing entries may involve deleting, nullifying or overwriting the removed entries.

In some implementations, the ownership table 400 may include optional validity indicators column 406, which may include a value for indicating whether the entry indicates current ownership of a computing device resource by the owner associated with the owner identifier of the same entry. Including the optional validity indicators column 406 may allow for storage of past, current, and potential entries of owners of computing device resources. Entries including a value indicating current ownership of a computing device resource may include a designated value in the optional validity indicators column 406, such as a boolean value “1” as illustrated in rows 408, 410, and 414. Entries including a value indicating past or potential ownership of a computing device resource may include a different designated value in the optional validity indicators column 406, such as a boolean value “0” as illustrated in row 412. Implementations including the optional validity indicators column 406 may retain entries of non-current ownership in response to a change in ownership of a computing device resource. Embodiments including the optional validity indicators may add new entries to the ownership table 400 as ownership of a computing device resource is taken, or the ownership table 400 may be pre-populated with some or all of the possible combinations of computing device resources and their potential owners. In some implementations, there may be a limit “N” on the number of entries in the ownership table 400, and entries may be removed according to a replacement criterion in order to add current or potential ownerships.

The example ownership table 400 illustrates a variety of ownership circumstances that may be addressed in various implementations. For example, row 408 illustrates an owner entity designated by the owner identifier “O1” may own a computing device resource represented by a virtual resource identifier “VA1” according to the virtual resource identifier to computing device resource mapping for the owner and the computing device resource. In various implementations, the virtual resource identifier “VA1” may be a virtual address mapped to a physical address for the owner and the computing device resource. In implementations excluding the optional validity indicators column 406, the presence of the data in row 408 may indicate that the owner entity designated by the owner identifier “O1” currently owns the computing device resource represented by the virtual resource identifier “VA1”. The same outcome may be indicated in examples including the optional validity indicators column 406, as the validity indicator's value is “1”.

The further inclusion of row 410 illustrates that the same owner entity of row 408 may also own a computing device resource represented by a virtual resource identifier “VA2” according to the virtual resource identifier to computing device resource mapping for the owner and the computing device resource.

Row 412 illustrates that an owner entity designated by the owner identifier “O2” may be an owner of a computing device resource represented by a virtual resource identifier “VB1” according to the virtual resource identifier to computing device resource mapping for the owner and the computing device resource. However, the validity indicator value of “0”, in the optional validity indicators column 406, may indicate that the owner entity designated by the owner identifier “O2” is a past or potential owner, rather than a current owner, of the computing device resource indicated by the virtual resource identifier “VB1”. In some implementations excluding the optional validity indicators column 406, the row 412 may be omitted from the ownership table 400.

FIG. 5 illustrates a non-limiting example of a certification table 500 that the data protection system 300 may use to store data of the function certifications of past, current, and/or potential requesting entities for computing device resources. Various implementations may include different combinations and ordering of function certification data, including requesting entity identifiers, certificate data or certificate data references, and access types.

In some implementations, the terms certificate data and certificate data references may be used interchangeably. The example certification table 500 includes a requesting entity identifiers column 502 and a certificates column 504. As discussed further herein, the certification table 500 may also include an optional access types column 506. The certification table 500 may include multiple rows, for example, rows 508-514, each representing different certified function of a requesting entity for computing device resources.

The requesting entity identifiers column 502 may include unique identifiers for each requesting entity or potential requesting entity of the computing device. The requesting entity identifiers may be used to communicate the identity of an entity requesting access to a computing device resource.

The certificates column 504 may include a certificate for a requesting entity or for a function of the requesting entity, or a reference, such as a pointer, to a location at which the certificate is stored. In some implementations, the certification table 500 only includes entries for current requesting entities for computing device resources. In such implementations, an entry may be removed from the certification table 500 in response to a change in ownership of a computing device resource, so that no owners requesting access to their respective owned computing device resources may be listed in the certification table 500. Removing entries may involve deleting, nullifying or overwriting the removed entries.

In some implementations, entries to the certification table 500 may be added as requests for access to computing device resources are made, or the certification table 500 may be pre-populated with some or all of the possible combinations of the potential requesting entities and their certificates. In some implementations, entries may be retained despite a change in ownership of a computing device resource. In some implementations, including owners as requesting entities in the certification table 500, ownership of the computing device resource may be confirmed before encrypting the virtual view of the resource contents. In some implementations, there may be a limit “M” on the number of entries in the certification table 500, and entries may be removed according to a replacement criterion in order to add current or potential requesting entities.

In some implementations, the certification table 500 may include an optional access types column 506, which may include a value for indicating the type of access to the resource contents that the requesting entity is permitted. Including the optional access types column 506 may allow for faster encryption as less time and resources may be spent determining the type of encryption to employ. Entries including a value indicating access types for a requesting entity and a certified function may include an identifier of the access type correlated with a type and/or level of encryption, or include an identifier of the type and/or level of encryption. The value in the optional access types column 506 may correlate with the certified function and/or whether the requesting entity is an owner.

In some implementations, an owner requesting entity may be granted unobscured access to the resource content for a certified function, or regardless of the function. Row 508 illustrates an example of a requesting entity that is also an owner of the requested computing device resource. Rows 510-514 illustrate requesting entities that are not owners of the requested computing device resources. The certified function of each of the requesting entities in rows 510-514 may be correlated with a specified access type controlling the type and/or level of encryption the data protection system 300 may apply to the virtual view of the requested resource contents provided to the requesting entity. For example, row 510 indicates that the certificate “CA2” for the requesting entity “R1” may allow for only partial obscuring of the virtual view of the requested resource contents. The data protection system 300 may apply full or partial homomorphic encryption to the virtual view of the requested resource contents for a request made by the requesting entity “R1”. Similarly, rows 512 and 514 indicates that the certificates “CB1” and “CC1” for the requesting entities “R2” and “RN”, respectively, may allow for only obscuring of the virtual view of the requested resource contents. The data protection system 300 may apply strong encryption to the virtual view of the requested resource contents for requests made by the requesting entities “R2” and “RN”.

The components of the data protection system 300, the virtualization interface monitor 302, the resource content cryptographic device 304, the ownership table 400, and the certification table 500, may be arranged differently in various implementations without departing from the scope of the claims. In some implementations, the ownership table 400 and the certification table 500 may be combined, split into more tables, or include one or more items described to be included in the other of the ownership table 400 and the certification table 500.

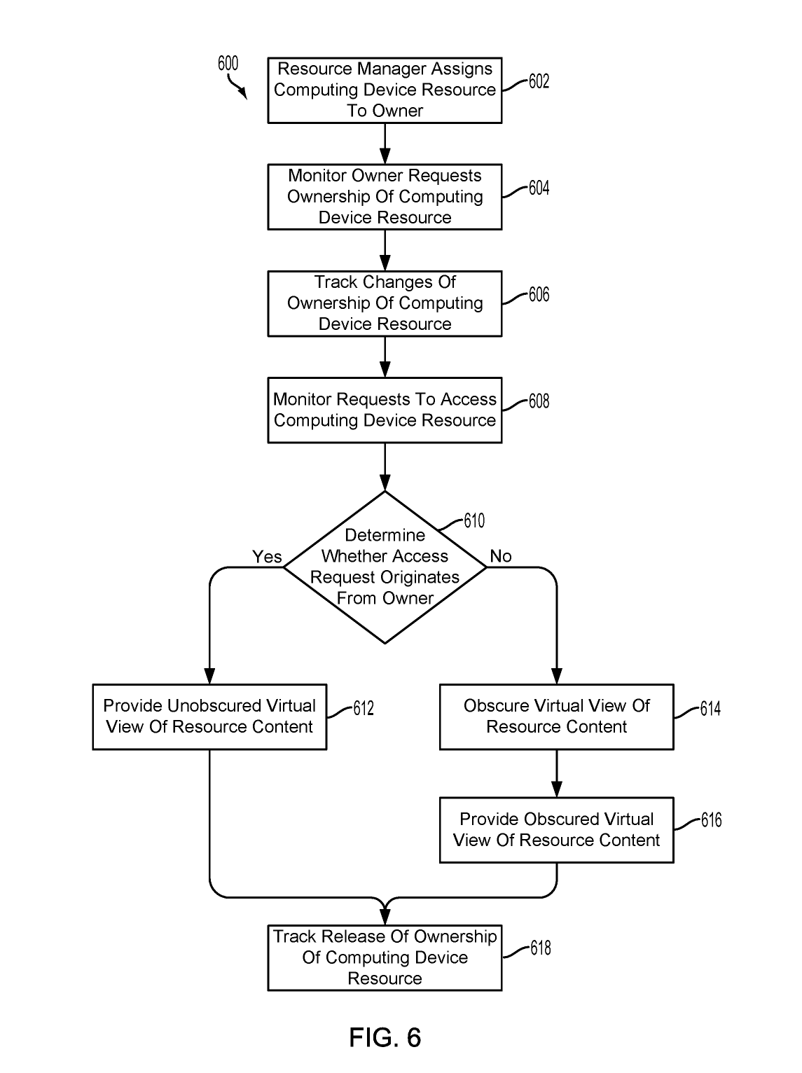

FIG. 6 illustrates a method 600 for protecting data using virtual resource views according to various embodiments. The method 600 may be executed in a computing device using software executing on general purpose hardware, such as a processor, and/or on dedicated hardware implementing the data protection system, the virtualization interface monitor, and/or the resource content cryptographic device.

In block 602, the computing device may execute a resource manager to assign ownership of a computing device resource to an owner. As discussed above, the resource manager may include the operating system, the hypervisor, and/or the TrustZone, and the owner may include the application, the operating system, the hypervisor, and/or the TrustZone. Assigning ownership of the computing device resource to the owner allows the resource manager to grant ownership to the owner if the owner is prepared to take ownership of the computing device resource. For example, ownership of the computing device resource may be assigned to the owner, but the owner may be waiting for other resources to become available or other processes to complete before being ready to take ownership of the computing device resource. The assignment of ownership of the computing device resource may expire if ownership is not taken within a time period, thereby making the computing device resource available for assignment to other owners. In some embodiments, the assignment of ownership of the computing device resource may be responsive to a request for ownership, a next owner in a queue for ownership, a first owner to respond to direct signal or a broadcast of availability of the resource, or an algorithm for determining a next owner based on various criteria, including power and performance parameters.

In block 604, the computing device may monitor requests for ownership of the computing device resources by the assigned owner. In some embodiments, the assigned owner of the computing device resource may request ownership of the computing device to acknowledge acceptance of the assignment of ownership of the computing device resource. In some embodiments, the request for ownership of the computing device resource may signal to other components, systems, and/or potential owners of the assigned owner's ownership of the computing device resource. To monitor a request for ownership of the computing device resource by the assigned owner, components of the computing device, such as the processor, the data protection system and/or the virtualization interface monitor, may receive, detect, or intercept the request for ownership of the computing device resources.

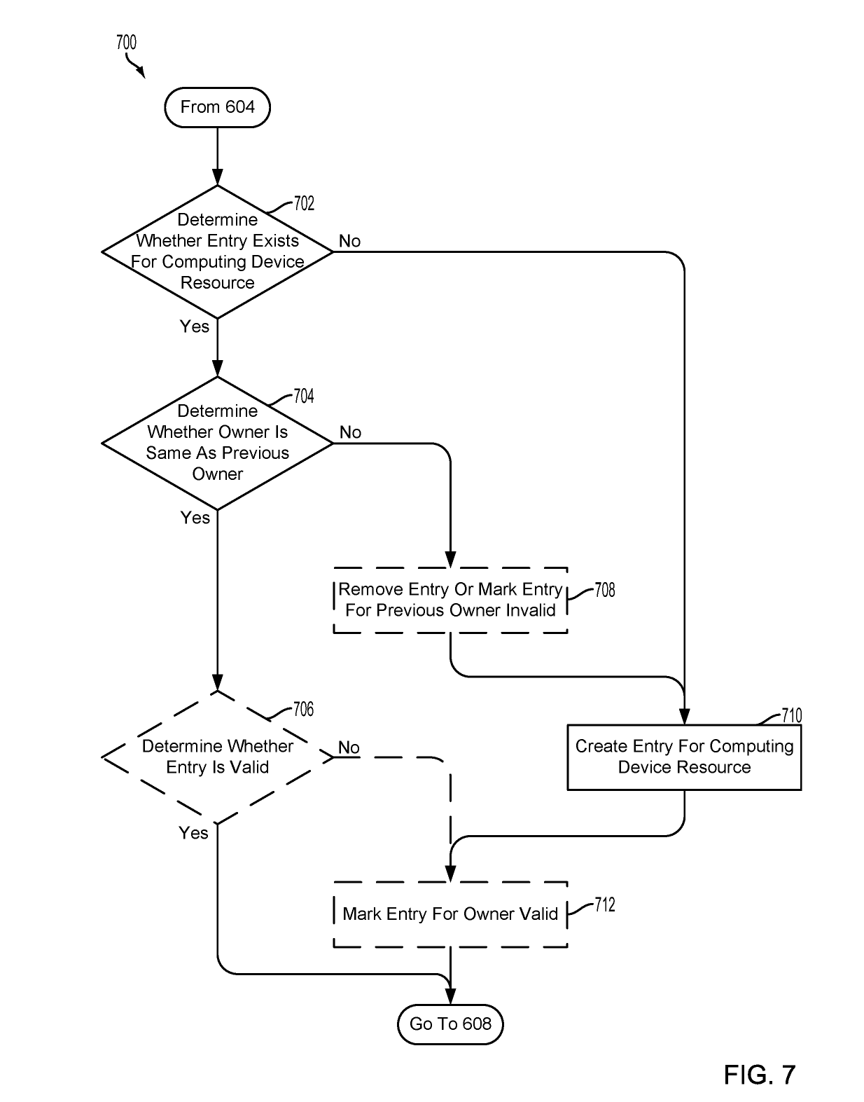

In block 606, the computing device may track changes of ownership of the computing device resource. Components of the computing device, such as the processor, the data protection system and/or the virtualization interface monitor may use information of the request for ownership of the computing device resource to determine the entity that is the owner of the computing device resource. To track the ownership of the computing device resource, the computing device may update a table or data structure, such as an ownership table as described further with respect to a method 700 with reference to FIG. 7.

In block 608, the computing device may monitor requests to access the computing device resources by any entity, owner, or non-owner. In some embodiments, the owner of the computing device resource may request to access the computing device resource to read or write to the resource content. In some embodiments, non-owners may legitimately request access to the computing device resource to implement management functions of the resource content, such as moving, copying, or searching the resource content. However, some requests to access the computing device resource by non-owners may be prompted by malicious actors that have taken control of or influenced the non-owner to gain access to the resource content. To monitor the requests to access the computing device resources, components of the computing device, such as the processor, the data protection system and/or the virtualization interface monitor, may receive, detect, or intercept the request for access to the computing device resources. The computing device may extract information from the request to access the computing device resource, such as the virtual resource identifiers targeted in the request to access the computing device resource. Thereby, the computing device may monitor a virtualization interface of the computing device responsible for translating virtual resource identifiers of the computing device resources used in requests to access computing device resources and response to the requests. For example, the computing device may extract a virtual address of the computing device resource and monitor the virtualization interface responsible for the virtual address and physical address translations.

In determination block 610, the computing device may determine whether a monitored request to access the computing device resources originates from the owner of the computing device resource targeted in the request to access the computing device resource. Different entities, owners and non-owners, may employ different virtual resource identifiers to computing device resource maps for the same computing device resource. The virtualization interface may be used to identify which of the entities of the computing device issued a request to access the computing device resource.

As part of the operations in determination block 610, components of the computing device, such as the processor, the data protection system and/or the virtualization interface monitor, may use the information extracted from the request to access the computing device resource and compare it to information in the ownership table. In some implementations, the virtual resource identifier targeted in the request to access the computing device resource may be correlated with the requesting entity. The correlation may be made using the virtualization interface mappings to identify the entity that would make a request to the virtual resource identifier targeted in the request to access the computing device resource. In some implementations, the identified requester may be correlated with an entity identifier that may double as the owner identifier in the ownership table.

In some implementations, the entity identifier and/or the virtual resource identifier relating to the request to access the computing device resource may be compared to entries of the same types of information in the ownership table to determine whether a match is found. In some implementations, the ownership table may only contain entries of current owners, and a match may indicate that the requester is the owner, while no match may indicate that the requester is a non-owner. In some implementations, the ownership table may include entries of past, current, and/or potential owners of computing device resources, and additional information from the ownership table, like a validity indicator, may be checked to determine whether a match also indicates that the requester is the owner or a non-owner. For example, the validity indicator may indicate that the matching entry is valid indicating that the requester is the owner. Conversely, the validity indicator may indicate that the matching entry is invalid indicating that the requester is a non-owner.

In response to determining that the monitored request to access the computing device resource originates from the owner of the computing device resource targeted in the request to access the computing device resource (i.e., determination block 610=“Yes”), the computing device may provide an unobscured/unencrypted virtual view of the resource content provided in response to the request to access the computing device resource in block 612. The request to access the computing device resource for a specified virtual resource identifier may prompt the computing device to return the resource contents of computing device resource to the requester. In some implementations, the computing device may be configured to provide the resource contents as a virtual view. As such, the computing device may be able to protect the resource contents from becoming corrupted in case of a bug or error during processing of the resource contents by a requesting entity. The computing device may also be able to provide multiple entities different access to the resource contents concurrently by using virtual views. In some implementations, the owner of the computing device resource may be trusted not to be used for malicious access to the resource contents, so the owner is provided with an unobscured/unencrypted virtual view of the resource content from the owner computing device resource. In some implementations, components of the computing device, including the processor, the data protection system and/or the resource content cryptographic device, may generate or pass the virtual view of the resource content without obscuring/encrypting the virtual view. In some implementations, the computing device components may be bypassed as obscuring/encrypting the virtual view of the resource contents is not needed.

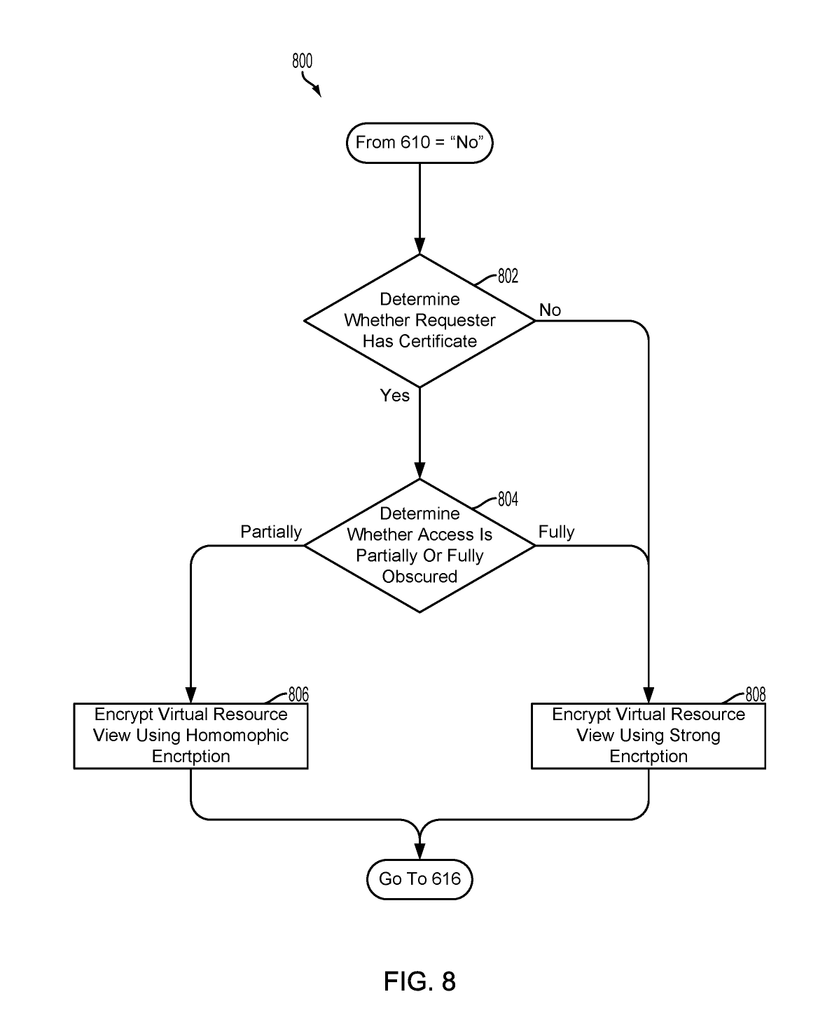

In response to determining that the monitored request to access the computing device resource originates from a non-owner of the computing device resource targeted in the request to access the computing device resource (i.e., determination block 610=“No”), the computing device may obscure a virtual view of the resource content provided in response to the request to access the computing device resource in block 614. The computing device may determine a type and/or level of encryption to obscure the virtual view of the resource content, as described further with respect to method 800 with reference to FIG. 8. Components of the computing device, including the processor, the data protection system and/or the resource content cryptographic device, may obscure the virtual view of the resource content to protect the resource content from malicious access via the non-owners. In some implementations, obscuring the virtual view of the resource content does not prohibit the non-owners from implementing legitimate access and managerial functions without having a clear view of the resource contents. In an example, the resource contents may be of no consequence when being moved in blocks as the resource contents do not change, only their location is changed, nor does the entity moving the resource content need to know the specifics of the data of the resource content. In another example, partially obscuring the resource content may allow some searching and arithmetic manipulation of the cipher text that may suffice to implement functions by non-owners providing the necessary feedback or corresponding changes in the unobscured resource content.

In block 616, the computing device may provide the obscured/encrypted virtual view of the resource content. Similar to the provision of unobscured/unencrypted virtual views in block 612, the computing device may provide the virtual view of the resource contents to the requesting entity. However, the virtual views provided to the non-owners are obscured/encrypted.

In block 618, the computing device may track releases of owned computing device resources. In a manner similar to monitoring the requests for ownership of the computing device resources in block 604, the computing device may receive, detect, or intercept a signal indicating the release of the owned computing device resources. The release signal may notify other entities and components of the computing device that the computing device resource is available for ownership. In some embodiments, components of the computing device, such as the processor, the data protection system and/or the virtualization interface monitor, may update the ownership table in response to the release signal. In some embodiments, the entry indicating the ownership of the computing device resource by the former owner may be removed from or marked invalid in the ownership table.

FIG. 7 illustrates a method 700 for tracking ownership of computing device resources according to various embodiments. The method 700 may be executed in a computing device using software executing on general purpose hardware, such as a processor, and/or on dedicated hardware implementing the data protection system, the virtualization interface monitor, and/or the resource content cryptographic device.

In determination block 702, the computing device may determine whether an entry exists in the data structure or table, such as the ownership table, for a computing device resource. Components of the computing device, such as the processor, the data protection system and/or the virtualization interface monitor, may compare virtual resource identifiers of the requests to access computing device resources to values of corresponding information stored in entries of the ownership table. An entry having the same virtual resource identifier of the request to access the computing device resource may indicate that an entry exists for the computing device component. Further, since different owners may use different virtual resource identifiers to map to the same computing device resource, the entry having the virtual resource identifier may indicate that the entry exists for the computing device component owned by the requesting owner. Lack of an entry having the same virtual resource identifier of the request to access the computing device resource may indicate that no entry exists for the computing device component. However, lack of an entry having the same virtual resource identifiers of the request to access the computing device resource may rather indicate lack of an entry for the computing device component being in the past, currently, or potentially owned by the current owner requesting ownership of the computing device resource. Since different owners may use different virtual resource identifiers to map to the same computing device resource, entries may exist for other past, current, or potential owners of the computing device. In some implementations, the computing device may also check virtual resource identifiers of the computing device component used by other past, current, or potential owners.

In response to determining that an entry does not exist in the ownership table for computing device resource (i.e., determination bock 702=“No”), the computing device may create an entry in the ownership table for the computing device resource in block 710. Components of the computing device, such as the processor, the data protection system and/or the virtualization interface monitor, may write data, including the virtual resource identifier of the request for ownership of the computing device resource and/or an identified owner identifier correlated to the virtual resource identifier, to the ownership table to edit an existing entry or create a new entry. In some implementations, existing entries may be stale or no longer relevant to the state of ownership of the resources of the computing device and may be overwritten.

In some embodiments, in optional block 712, the computing device may mark the new entry for the requesting owner of the computing device resource as valid, as described in further detail herein. The computing device may proceed to monitor requests to access the computing device resources by any entity in block 608 as described with reference to FIG. 6.

In response to determining that an entry does exist in the ownership table for computing device resources (i.e., determination bock 702=“Yes”), the computing device may determine whether the requesting owner of the computing device resources is the same as a previous owner of the computing device resource in determination block 704. As discussed herein, the owner, past, current, or potential, of the computing device resource may be identified by the virtual resource identifier of the request for ownership of the computing device resource or a correlated owner identifier. Components of the computing device, such as the processor, the data protection system and/or the virtualization interface monitor, may compare data of the ownership request for the computing device resource and the identified entries to determine whether the requesting owner is the same as an owner listed in an entry for the same computing device resource.

In response to determining that a requesting owner of the computing device resource is not the same as a previous owner of the computing device resource (i.e., determination block 704=“No”), the computing device may remove or mark invalid an entry for a computing device resource with a different owner in optional block 708. Components of the computing device, such as the processor, the data protection system and/or the virtualization interface monitor, may remove any entry with a different owner of the same computing device resource as the computing device resource ownership request. In some embodiments, the entries with different owners for the same computing device resource as the computing device resource ownership request may be maintained but marked as invalid by setting a validity indicator for the entry in the ownership table. Other entries for the same computing device resource may be identified by their virtual resource identifiers and their respective mappings to the same computing device resource.

In block 710, the computing device may create an entry in the ownership table for the computing device resource, and in optional block 712, the computing device may mark the new entry for the requesting owner of the computing device resource as valid, as described further herein. The computing device may monitor requests to access the computing device resource by any entity in block 608 as described with reference to FIG. 6.

In response to determining that requesting owner of the computing device resource is the same as a previous owner of the computing device resource (i.e., determination block 704=“Yes”), the computing device may determine whether the entry for the same owner as the requesting owner of the computing device resource is valid in optional determination block 706. Components of the computing device, such as the processor, the data protection system and/or the virtualization interface monitor, may check the value of a validity indicator for the entry in the ownership table for the same computing device resource and owner.

In response to determining that the entry for the same owner as the requesting owner of the computing device resource is valid (i.e., determination block 706=“Yes”), the computing device may monitor requests to access the computing device resource by any entity in block 608 as described with reference to FIG. 6.

In response to determining that the entry for the same owner of the computing device resource is invalid (i.e., determination block 706=“No”), the computing device may mark the entry for the same owner of the computing device resource as valid in optional block 712. Components of the computing device, such as the processor, the data protection system and/or the virtualization interface monitor, may modify the value of the validity indicator in the ownership table to indicate that the entry is valid rather than invalid. The computing device may monitor requests to access the computing device resources by any entity in block 608 as described with reference to FIG. 6.

FIG. 8 illustrates an embodiment method 800 for using certifications for applying encryption to virtual views of resource content. The method 800 may be executed in a computing device using software executing on general purpose hardware, such as a processor, and/or on dedicated hardware implementing the data protection system, the virtualization interface monitor, and/or the resource content cryptographic device.

In block 802, the computing device may determine whether a non-owner computing device resource access requester is associated with a certificate for a function. As discussed herein, the non-owner resource managers and applications, or non-owner requesting entities, may make computing device resource access requests for computing device resources they do not own. The resource managers and applications may be configured to execute functions that are certified by the developers or by a compiler of the computing device. The certification of the function may indicate a level of access to the resource content allowed for non-owner requesting entities. Components of the computing device, including the processor, the data protection system and/or the resource content cryptographic device, may determine whether entries exist in the data structure or table, such as the certification table, for the non-owner requesting entities. A requesting entity identifier may indicate an entry in the certification table for a correlated non-owner requesting entity. A lack of an entry in the certification table may indicate that the requesting entity is not certified.

In response to determining that the non-owner requesting entity is associated with a certificate for a function (i.e., determination block 802=“Yes”), the computing device may determine whether access to the resource contents is designated as partially or fully obscured in determination block 804. Components of the computing device, including the processor, the data protection system and/or the resource content cryptographic device, may retrieve an access type from the respective certificate correlated with the non-owner requesting entity, or from and entry for the non-owner requesting entity in the certification table. In some implementations, the certificate or a reference to the certificate may be stored in the entry for the non-owner requesting entity in the certification table. The computing device may retrieve the certificated from the certification table or from a location of the reference to the certificate. From the data of the certificate, the computing device may retrieve the access for the non-owner requesting entity. In some implementations, the certification table may include access types in the entries for the non-owner requesting entities, and the computing device may retrieve the access type from the corresponding entry in the certification table. As discussed herein, the access type may designate type and/or level of encryption, or level of obscuring, used in providing the virtual view of the resource contents to the non-owner requesting entity.

In response to determining that the access to the resource contents is designated as partially obscured (i.e., determination block 804=“Partially”), the computing device may obscure/encrypt the virtual view of the resource contents in block 806. Components of the computing device, including the processor, the data protection system and/or the resource content cryptographic device, may obscure/encrypt the virtual view of the resource contents using partial or full homomorphic encryption configured to prevent viewing, use, or manipulation of the resource contents, but allow for searching or arithmetic manipulation of the ciphertext. As discussed herein, the non-owner requesting entities may still implement some functions, searching or arithmetic manipulation of the ciphertext, without access to the resource contents, that result in similar results as if implementing the functions on the resource contents. In other words, the non-owner requesting entities may implement certain functions without being able to read, write, manipulate, or interpret the resource contents, but may still produce results similar to those if able to read, write, manipulate, or interpret the resource contents.

In response to determining that the non-owner requesting entity is not associated with a certificate for a function (i.e., determination block 802=“No”), or in response to determining that the access to the resource contents is designated as fully obscured (i.e., determination block 804=“Fully”), the computing device may obscure/encrypt the virtual view of the resource contents in block 808 as described further herein. Components of the computing device, including the processor, the data protection system and/or the resource content cryptographic device, may obscure/encrypt the virtual view of the resource contents using strong encryption configured to prevent viewing, use, or manipulation of the resource contents. As discussed herein, the non-owner requesting entities may still implement some functions, such as managerial functions, without access to the resource contents, but having access to an opaque block of data having the resource contents. In other words, the non-owner requesting entities may implement certain functions without being able to read, write, manipulate, or interpret the resource contents.

The computing device may provide the obscured/encrypted virtual view of the resource contents to the requesting entity in block 616 as described with reference to FIG. 6.

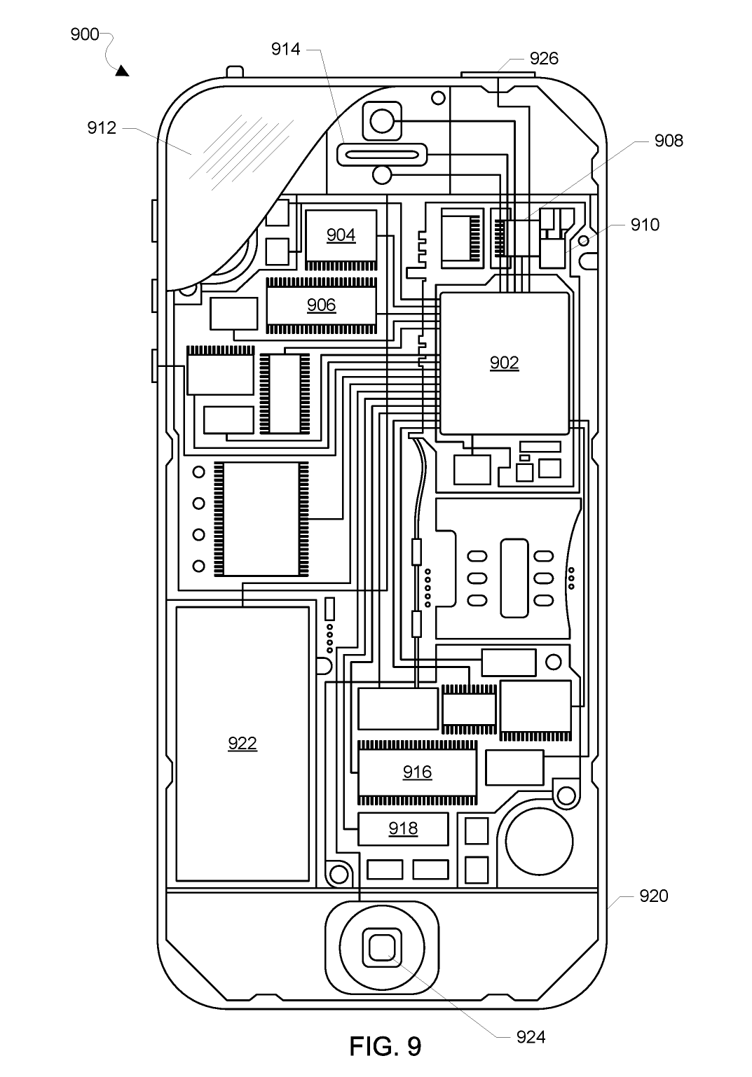

The various embodiments (including, but not limited to, embodiments discussed above with reference to FIGS. 1-8) may be implemented in a wide variety of computing systems, which may include an example mobile computing device suitable for use with the various embodiments illustrated in FIG. 9. The mobile computing device 900 may include a processor 902 coupled to an internal memory 906. The processor 902 may be one or more multi-core integrated circuits designated for general or specific processing tasks. The internal memory 906 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded dynamic random access memory (DRAM).

The processor 902 may be coupled to a display 912 of the mobile computing device, which may or may not have touch screen capability. In some implementations, the display 912 may be a touchscreen panel 912, such as a resistive-sensing touchscreen, capacitive-sensing touchscreen, infrared sensing touchscreen, etc. A touchscreen display 912 may be coupled to a touchscreen controller 904 and the processor 902. .

The mobile computing device 900 may have one or more radio signal transceivers 908 (e.g., Peanut, Bluetooth, ZigBee, Wi-Fi, RF radio) and antennae 910, for sending and receiving communications, coupled to each other and/or to the processor 902. The transceivers 908 and antennae 910 may be used with the above-mentioned circuitry to implement the various wireless transmission protocol stacks and interfaces. The mobile computing device 900 may include a cellular network wireless modem chip 916 that enables communication via a cellular network and is coupled to the processor.

The mobile computing device 900 may include a peripheral device connection interface 918 coupled to the processor 902. The peripheral device connection interface 918 may be singularly configured to accept one type of connection, or may be configured to accept various types of physical and communication connections, common or proprietary, such as USB, FireWire, Thunderbolt, or PCIe. The peripheral device connection interface 918 may also be coupled to a similarly configured peripheral device connection port (not shown).

The mobile computing device 900 may also include speakers 914 for providing audio outputs. The mobile computing device 900 may also include a housing 920, constructed of a plastic, metal, or a combination of materials, for containing all or some of the components discussed herein. The mobile computing device 900 may include a power source 922 coupled to the processor 902, such as a disposable or rechargeable battery. The rechargeable battery may also be coupled to the peripheral device connection port to receive a charging current from a source external to the mobile computing device 900. The mobile computing device 900 may also include a physical button 924 for receiving user inputs. The mobile computing device 900 may also include a power button 926 for turning the mobile computing device 900 on and off.

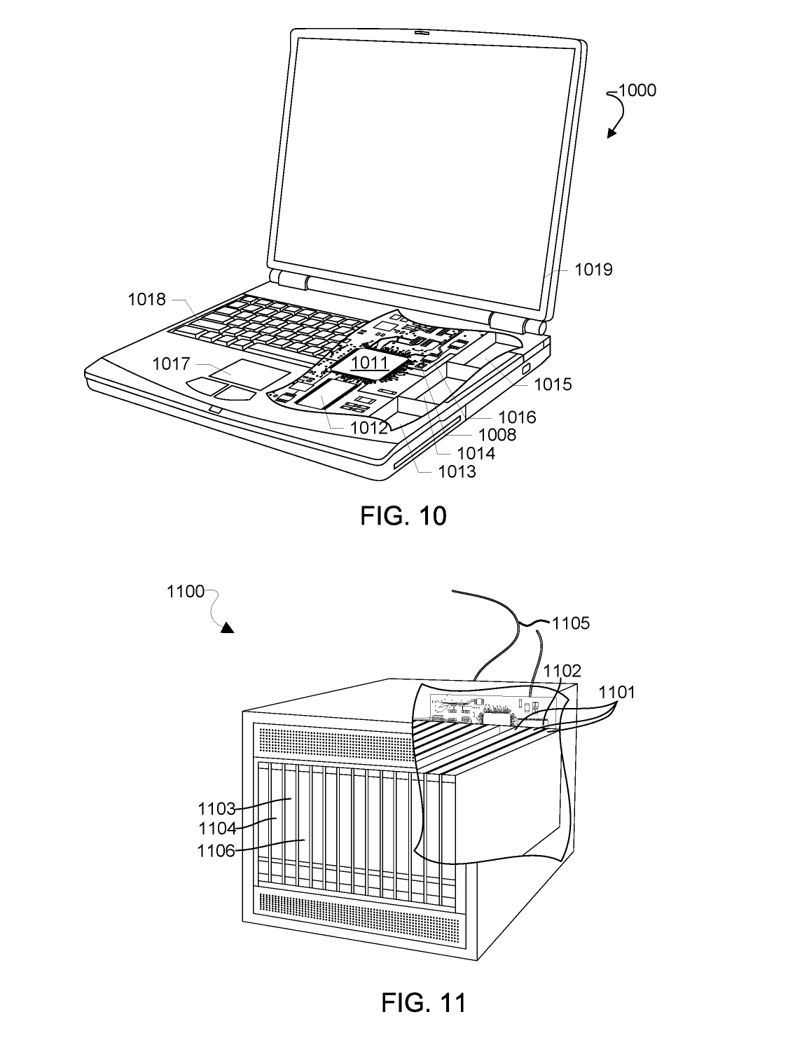

The various embodiments (including, but not limited to, embodiments discussed above with reference to FIGS. 1-8) may be implemented in a wide variety of computing systems, which may include a variety of mobile computing devices, such as a laptop computer 1000 illustrated in FIG. 10. Many laptop computers include a touchpad touch surface 1017 that serves as the computer's pointing device, and thus may receive drag, scroll, and flick gestures similar to those implemented on computing devices equipped with a touch screen display and described above. A laptop computer 1000 will typically include a processor 1011 coupled to volatile memory 1012 and a large capacity nonvolatile memory, such as a disk drive 1013 of Flash memory. Additionally, the computer 1000 may have one or more antenna 1008 for sending and receiving electromagnetic radiation that may be connected to a wireless data link and/or cellular telephone transceiver 1016 coupled to the processor 1011. The computer 1000 may also include a floppy disc drive 1014 and a compact disc (CD) drive 1015 coupled to the processor 1011. In a notebook configuration, the computer housing includes the touchpad 1017, the keyboard 1018, and the display 1019 all coupled to the processor 1011. Other configurations of the computing device may include a computer mouse or trackball coupled to the processor (e.g., via a universal serial bus (USB) input) as are well known, which may also be used in conjunction with the various embodiments.

The various embodiments (including, but not limited to, embodiments discussed above with reference to FIGS. 1-8) may be implemented in a wide variety of computing systems, which may include any of a variety of commercially available computing devices, such as servers. An example server 1100 is illustrated in FIG. 11. Such a server 1100 typically includes one or more multi-core processor assemblies 1101 coupled to volatile memory 1102 and a large capacity nonvolatile memory, such as a disk drive 1104. As illustrated in FIG. 11, multi-core processor assemblies 1101 may be added to the server 1100 by inserting them into the racks of the assembly. The server 1100 may also include a floppy disc drive, compact disc (CD) or DVD disc drive 1106 coupled to the processor 1101. The server 1100 may also include network access ports 1103 coupled to the multi-core processor assemblies 1101 for establishing network interface connections with a network 1105, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of protecting data using virtual views of resource contents, comprising:
monitoring, by a virtualization interface monitor of a computing device, a request to access a computing device resource by a first requesting entity;
determining, by the virtualization interface monitor, whether the first requesting entity is an owner of the computing device resource;
providing, by a data protection system of the computing device to the first requesting entity, an unobscured virtual view of resource contents of the computing device resource in response to determining that the first requesting entity is the owner of the computing device resource; and
providing, by the data protection system to the first requesting entity, an obscured virtual view of the resource contents of the computing device resource in response to determining that the first requesting entity is a non-owner of the computing device resource.

2. The method of claim 1, further comprising:
determining, by a resource content cryptographic device, whether the first requesting entity has a certified function;
determining, by the resource content cryptographic device, an access type for the first requesting entity in response to determining the first requesting entity has a certified function; and
obscuring, by a resource content cryptographic device of the computing device, the virtual views of the resource contents of the computing device resource in response to determining that the first requesting entity is a non-owner of the computing device resource using an obscuring level based on the access type.

3. The method of claim 2, wherein the access type includes partially obscured and obscured, and wherein obscuring the virtual views of the resource contents of the computing device resource using an obscuring level based on the access type comprises:
encrypting, by the resource content cryptographic device, the virtual views of the resource contents of the computing device resource using homomorphic encryption in response to determining that the access type for the first requesting entity is partially obscured; and
encrypting, by the resource content cryptographic device, the virtual views of the resource contents of the computing device resource using strong encryption in response to determining that the access type for the first requesting entity is obscured.

4. The method of claim 1, further comprising:
monitoring, by the virtualization interface monitor, a virtualization interface for changes in ownership of the computing device resource; and
storing, by the virtualization interface monitor, a first owner identifier of the first requesting entity correlated with a virtual resource identifier of the computing device resource for the first requesting entity, wherein the first owner identifier indicates the first requesting entity is granted ownership of the computing device resource and the virtual resource identifier is mapped to a physical resource identifier of the computing device resource.

5. The method of claim 4, wherein monitoring a virtualization interface for a change in ownership of the computing device resource comprises monitoring for a request for ownership of the computing device resource by a second requesting entity.

6. The method of claim 1, wherein determining whether the first requesting entity is an owner of the computing device resource comprises:
comparing, by the virtualization interface monitor, a virtual resource identifier of the request to access the computing device resource with a stored owner identifier of correlated with a virtual resource identifier of the computing device resource; and
determining that the first requesting entity is the owner of the computing device resource when the virtual resource identifier of the request to access the computing device resource and the virtual resource identifier of the computing device resource match.

7. The method of claim 1, wherein:
the owner of the computing device resource is an application; and
the non-owner of the computing device resource is a resource manager including one of an operating system kernel, a hypervisor, and a TrustZone.

8. A computing device, comprising:
a data protection system comprising a virtualization interface monitor and a resource content cryptographic device,
wherein the virtualization interface monitor is configured with virtualization interface monitor-executable instructions to perform operations comprising:
monitoring a request to access a computing device resource by a first requesting entity; and
determining whether the first requesting entity is an owner of the computing device resource, and
wherein the data protection system is configured with data protection system-executable instructions to perform operations comprising:
providing, to the first requesting entity, an unobscured virtual view of resource contents of the computing device resource in response to determining that the first requesting entity is the owner of the computing device resource; and
providing, to the first requesting entity, an obscured virtual view of the resource contents of the computing device resource in response to determining that the first requesting entity is a non-owner of the computing device resource.

9. The computing device of claim 8, wherein the resource content cryptographic device is configured with resource content cryptographic device-executable instructions to perform operations further comprising:
determining whether the first requesting entity has a certified function;
determining an access type for the first requesting entity in response to determining the first requesting entity has a certified function; and
obscuring a virtual view of the resource contents of the computing device resource in response to determining that the first requesting entity is a non-owner of the computing device resource.

10. The computing device of claim 9, wherein the access type includes partially obscured and obscured, and wherein the resource content cryptographic device is configured with resource content cryptographic device-executable instructions to perform operations such that obscuring the virtual view of the resource contents of the computing device resource using an obscuring level based on the access type comprises:
encrypting the virtual view of the resource contents of the computing device resource using homomorphic encryption in response to determining that the access type for the first requesting entity is partially obscured; and
encrypting the virtual view of the resource contents of the computing device resource using strong encryption in response to determining that the access type for the first requesting entity is obscured.

11. The computing device of claim 8, wherein the virtualization interface monitor is configured with virtualization interface monitor-executable instructions to perform operations further comprising:
monitoring a virtualization interface for changes in ownership of the computing device resource; and
storing a first owner identifier of the first requesting entity correlated with a virtual resource identifier of the computing device resource for the first requesting entity, wherein the first owner identifier indicates the first requesting entity is granted ownership of the computing device resource and the virtual resource identifier is mapped to a physical resource identifier of the computing device resource.

12. The computing device of claim 11, wherein the virtualization interface monitor is configured with virtualization interface monitor-executable instructions to perform operations such that monitoring a virtualization interface for a change in ownership of the computing device resource comprises monitoring for a request for ownership of the computing device resource by a second requesting entity.

13. The computing device of claim 8, wherein the virtualization interface monitor is configured with virtualization interface monitor-executable instructions to perform operations such that determining whether the first requesting entity is an owner of the computing device resource comprises:
comparing a virtual resource identifier of the request to access the computing device resource with a stored owner identifier of correlated with a virtual resource identifier of the computing device resource; and
determining that the first requesting entity is the owner of the computing device resource when the virtual resource identifier of the request to access the computing device resource and the virtual resource identifier of the computing device resource match.

14. The computing device of claim 8, further comprising a plurality of processors communicatively connected to the data protection system, and wherein:
the owner of the computing device resource is an application executing on a first processor of the plurality of processors; and
the non-owner of the computing device resource is a resource manager including one of an operating system kernel, a hypervisor, and a TrustZone executing on a second processor of the plurality of processors.

15. A computing device configured for protecting data using virtual views of resource contents, comprising:
means for monitoring a request to access a computing device resource by a first requesting entity;
means for determining whether the first requesting entity is an owner of the computing device resource;
means for providing, to the first requesting entity, an unobscured virtual view of resource contents of the computing device resource in response to determining that the first requesting entity is the owner of the computing device resource; and
means for providing, to the first requesting entity, an obscured virtual view of resource contents of the computing device resource in response to determining that the first requesting entity is a non-owner of the computing device resource.

16. The computing device of claim 15, further comprising:
means for determining whether the first requesting entity has a certified function; and
means for determining an access type for the first requesting entity in response to determining the first requesting entity has a certified function; and
means for obscuring the virtual views of the resource contents of the computing device resource in response to determining that the first requesting entity is a non-owner of the computing device resource using an obscuring level based on the access type.

17. The computing device of claim 16, wherein the access type includes partially obscured and obscured, and wherein means for obscuring the virtual views of the resource contents of the computing device resource using an obscuring level based on the access type comprises:
means for encrypting the virtual views of the resource contents of the computing device resource using homomorphic encryption in response to determining that the access type for the first requesting entity is partially obscured; and
means for encrypting the virtual views of the resource contents of the computing device resource using strong encryption in response to determining that the access type for the first requesting entity is obscured.

18. The computing device of claim 15, further comprising:
means for monitoring a virtualization interface for changes in ownership of the computing device resource; and
means for storing a first owner identifier of the first requesting entity correlated with a virtual resource identifier of the computing device resource for the first requesting entity, wherein the first owner identifier indicates the first requesting entity is granted ownership of the computing device resource and the virtual resource identifier is mapped to a physical resource identifier of the computing device resource.

19. The computing device of claim 18, wherein means for monitoring a virtualization interface for a change in ownership of the computing device resource comprises means for monitoring for a request for ownership of the computing device resource by a second requesting entity.

20. The computing device of claim 15, wherein means for determining whether the first requesting entity is an owner of the computing device resource comprises:
means for comparing a virtual resource identifier of the request to access the computing device resource with a stored owner identifier of correlated with a virtual resource identifier of the computing device resource; and
means for determining that the first requesting entity is the owner of the computing device resource when the virtual resource identifier of the request to access the computing device resource and the virtual resource identifier of the computing device resource match.

21. The computing device of claim 15, wherein:
the owner of the computing device resource is an application; and
the non-owner of the computing device resource is a resource manager including one of an operating system kernel, a hypervisor, and a TrustZone.

22. A non-transitory processor-readable storage medium having stored thereon processor-executable instructions configured to cause a processor of a computing device to perform operations comprising:
monitoring a request to access a computing device resource by a first requesting entity;
determining whether the first requesting entity is an owner of the computing device resource;
providing, to the first requesting entity, an unobscured virtual view of resource contents of the computing device resource in response to determining that the first requesting entity is the owner of the computing device resource; and
providing, to the first requesting entity, an obscured virtual view of resource contents of the computing device resource in response to determining that the first requesting entity is a non-owner of the computing device resource.

23. The non-transitory processor-readable storage medium of claim 22, wherein the stored processor-executable instructions are configured to cause the processor to perform operations further comprising:
determining whether the first requesting entity has a certified function;
determining an access type for the first requesting entity in response to determining the first requesting entity has a certified function; and
obscuring a virtual view of the resource contents of the computing device resource in response to determining that the first requesting entity is a non-owner of the computing device resource using an obscuring level based on the access type.

24. The non-transitory processor-readable storage medium of claim 23, wherein the access type includes partially obscured and obscured, and wherein the stored processor-executable instructions are configured to cause the processor to perform operations such that obscuring the virtual view of the resource contents of the computing device resource using an obscuring level based on the access type comprises:
encrypting the virtual view of the resource contents of the computing device resource using homomorphic encryption in response to determining that the access type for the first requesting entity is partially obscured; and
encrypting the virtual view of the resource contents of the computing device resource using strong encryption in response to determining that the access type for the first requesting entity is obscured.

25. The non-transitory processor-readable storage medium of claim 22, wherein the stored processor-executable instructions are configured to cause the processor to perform operations further comprising:
monitoring a virtualization interface for changes in ownership of the computing device resource; and
storing a first owner identifier of the first requesting entity correlated with a virtual resource identifier of the computing device resource for the first requesting entity, wherein the first owner identifier indicates the first requesting entity is granted ownership of the computing device resource and the virtual resource identifier is mapped to a physical resource identifier of the computing device resource.

26. The non-transitory processor-readable storage medium of claim 25, wherein the stored processor-executable instructions are configured to cause the processor to perform operations such that monitoring a virtualization interface for a change in ownership of the computing device resource comprises monitoring for a request for ownership of the computing device resource by a second requesting entity.

27. The non-transitory processor-readable storage medium of claim 22, wherein the stored processor-executable instructions are configured to cause the processor to perform operations such that determining whether the first requesting entity is an owner of the computing device resource comprises:
comparing a virtual resource identifier of the request to access the computing device resource with a stored owner identifier of correlated with a virtual resource identifier of the computing device resource; and
determining that the first requesting entity is the owner of the computing device resource when the virtual resource identifier of the request to access the computing device resource and the virtual resource identifier of the computing device resource match.

28. The non-transitory processor-readable storage medium of claim 22, wherein:
the owner of the computing device resource is an application; and
the non-owner of the computing device resource is a resource manager including one of an operating system kernel, a hypervisor, and a TrustZone.
